(19) United States
(12) Patent Application Publication
(10) Pub. No.: US 2006/0231984 A1
(43) Pub. Date: Oct. 19, 2006

(54) Oriented container and method of manufacture

(75) Inventor: Luis Carvallo, Owings Mills, MD (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 11/104,510

(22) Filed: Apr. 13, 2005

(51) Int. Cl. B65B 7/00; B29C 49/00

(52) U.S. Cl. 264/523; 156/69

(57) ABSTRACT

The present invention speaks to an oriented, blow molded container and the method of making comprising stretch blow molding the container from a preform, the container having an outside feature and a finish with an attachment component, the attachment component having a predetermined orientation relative to the outside feature of the container; molding a closure having an attachment component, the attachment component having a predetermined orientation relative to an outside feature of the closure; and assembling the attachment component of the closure and the attachment component of the container, such that the outside feature of the closure has a specified orientation relative to the outside feature of the container.

### BACKGROUND OF THE INVENTION

1. Field of the Invention

The present invention relates generally to containers and more particularly to oriented containers with a blown finish.

2. Related Art

Stretch blow molding involves the use of a preform from which the container is formed. In this method, the threads of the preform become the threads of the container. This method is well-suited for containers having a closure with a uniform exterior, such as closures that look identical from all angles.

It is becoming more frequent for closures to sport a particular feature that requires aligning the closure relative to the container. For example, a closure may have a spout where it is preferable for the spout to line up with the front of the container. Shampoo bottles frequently have such a requirement. Therefore, container threads need to be manufactured such that the closure, when screwed all the way on, is situated in a certain position relative to the container. This requires that the threads also have a certain orientation relative to the container. Preform threads are not suitable for this purpose.

In extrusion blow-molding, threads are blown with the container in a mold. Though this process allows for the creation of container-specific threads, it is desirable to have a method of stretch blow molding that results in container threads that allow a closure to be specifically oriented relative to the container.

U.S. Pat. No. 6,228,317 to Smith discloses a method of manufacture for a wide mouth PET plastic container having an externally-threaded finish. Here the threads of the container are blow molded separately from the threads of the preform, and preform threads are removed as waste. However, this patent only addresses wide mouth containers for hot fill applications, and is not designed to blow threads that result in a specific orientation of an attachment, such as a closure. There remains a need in the art for a method of manufacturing containers having threads that allow a particular orientation of, for example, a cap, relative to the container.

### BRIEF SUMMARY OF THE INVENTION

The present invention relates to a PET container and an attachment, each having an orientation component allowing a specific orientation of the attachment relative to the container, and methods for manufacture. The method includes stretch blow molding the container from a preform, the container having an outside feature and a finish with an orientation component. The orientation component of the container has a predetermined orientation relative to the outside feature of the container. The method also includes molding an attachment having an outside feature and an orientation component, where the orientation component of the attachment also has a predetermined orientation relative to the outside feature of the closure. Additionally, the method involves assembling the orientation components of each the attachment and the container, such that the outside feature of the attachment has a specified orientation relative to the outside feature of the container.

The invention also speaks to the container and attachment manufactured by the method described above.

In an exemplary embodiment, the outside feature of the attachment is a dispensing feature. In another embodiment, the orientation component of the finish comprises a stop. The outside feature of the container can be a polygonal cross section, a geometric shape, or a label-receiving surface. In an additional embodiment, the outside feature is embossed on the attachment.

The method can further include the creation of a moil on the container during the blow molding process. The moil is then removed. The method can also include the step of heating the preform before stretch blow-molding the container. In an alternative embodiment, the preform is injection molded prior to blow molding the container.

The attachment can be injection blow-molded. In an alternate embodiment, the orientation components form a bayonet connection. In yet another embodiment, the orientation components are threads.

The invention also addresses a method of assembling a PET plastic container having a face and an attachment in a desired orientation. The method includes blow molding the container from a preform, where the container has a finish with an orientation component. The orientation component of the container has a predetermined orientation relative to the face of the container. The method further includes molding the attachment with an orientation component, the orientation component of the attachment having a predetermined orientation relative to an outside feature of the attachment. Additionally, the method includes connecting the attachment to the container via the orientation components, such that the outside feature of the attachment has a specified orientation relative to the face of the container.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts two mold halves coming together to form the mold;

FIG. 2 depicts a preform situated in the mold prior to stretch blow molding the preform;

FIG. 3 depicts the preform once it has been stretch blow molded to form the container, with the moil still present;

FIG. 4 depicts the blow molded container as the mold halves retract;

FIG. 5 depicts the container once the moil is removed;

FIG. 6 depicts the non-round cross section of the container of FIG. 5;

FIG. 7 depicts an exemplary embodiment of a closure according to the present invention;

FIG. 8 depicts an internal view of the closure of FIG. 7, showing the attachment component;

FIG. 9 depicts the container and closure of the present invention, prior to assembly, according to one exemplary embodiment;

FIG. 10 depicts another exemplary embodiment of the assembled container and attachment of the invention, where an outside feature of the attachment has a specific orientation relative to the cross section of the container.

FIG. 11 depicts a front view of an exemplary embodiment of the container having a stop feature.

FIG. 12 depicts a side view of an exemplary embodiment of the container having a stop feature.

FIG. 13 depicts an exemplary embodiment of the assembled container and attachment, where the attachment is a dispensing feature.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

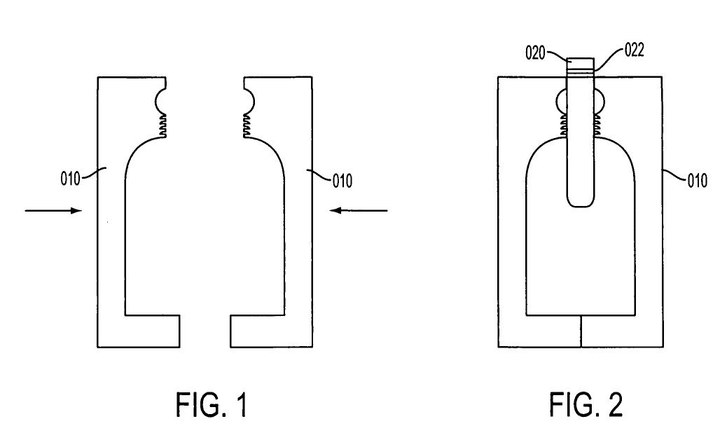

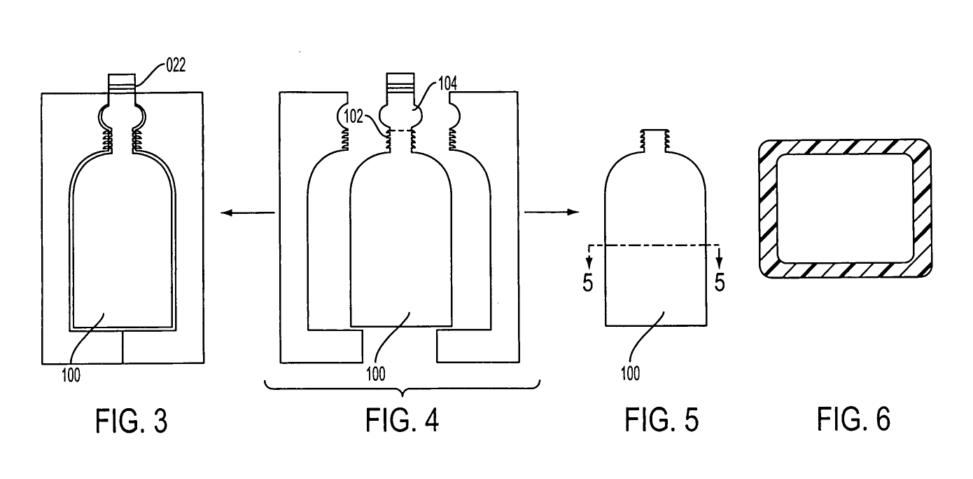

In the process of the present invention, a preform 020 with threads 022 is placed in a mold cavity that is comprised of two halves 010 (See FIGS. 1 and 2). The mold is that of a container having an orientation component. As illustrated in FIG. 2, the orientation component is threads. The preform 020 is then blow molded to form a container 100 that takes the shape of the mold cavity (See FIG. 3). At this point, the container 100 is in an intermediate stage, having both the threads 022 of the preform 020, and the orientation component 102 of the container 100 (See FIG. 4).

Optionally, the preform can be heated prior to blow molding the container. The preform can also be injection molded prior to blow molding the container. Importantly, the preform used in the present invention is designed to provide adequate materials in the finish area to support closure and prevent ovalization.

Once the container 100 has been formed, the two mold haves 010 retract (see FIG. 4). The moil 104, which may include the portion of the preform 020 including the threads 022 and any excess plastic that results from the blow molding process, is then removed to yield the container 100 of the present invention (See FIG. 5).

The container of the present invention can have a non-round cross section, as illustrated in FIG. 6. For example, the cross-section may be square, triangular, pentagonal, etc., or any other polygon shape. The cross-section may also have rounded edges. The container is made of polyethlene therepthalate (PET), but other known plastics may be used. The attachments are also made of PET, but high density plastic, or other suitable plastics known in the art, can also be used.

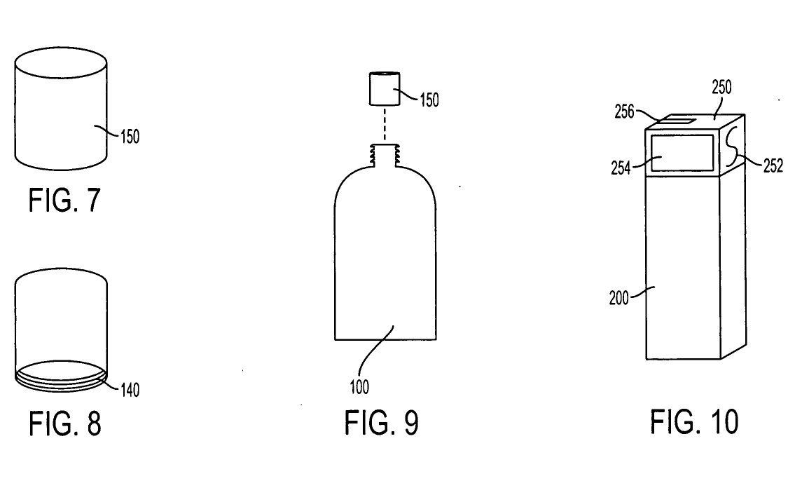

Once the moil is removed, the attachment 150 can be placed on the container 100. The attachment may be a variety of shapes, such as circular or polygonal, as illustrated in FIGS. 7 and 8 (internal view). Other shapes not pictured are also contemplated by the present invention. The attachment has an orientation component 140 (see FIG. 8). In the illustrated embodiments, the orientation components of both the container 100 and attachment 140 are threads. In another embodiment the attachment components can form a bayonet-type connection.

As illustrated in FIG. 9, the orientation component 102 of the container 100 is adapted to fit an attachment such that when the attachment 150 is attached to the container 100, the attachment is oriented in a particular fashion relative to the container 100. For example, the attachment 150 is oriented relative to the cross section of the container 100. Additionally, the attachment 150 may contain an outside feature such as a dispensing feature, a label-receiving surface, an embossment, or any sort of design. This outside feature has a specific orientation relative to the container 100 due to the attachment feature 102 that is blown with the container 100.

As illustrated in FIG. 10, the attachment 250 can have a spout 256. The orientation feature of the container 200 allows the spout 256 to line up with the front face of the container regardless of how the attachment 250 is initially placed on the container. There may also be a label-receiving surface 254 or an embossment 252 on either the attachment or the container 200 such that it is desirable to have the attachment 250 orient itself in a particular fashion relative to the container 100.

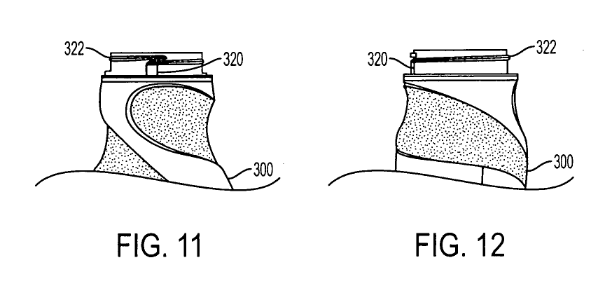

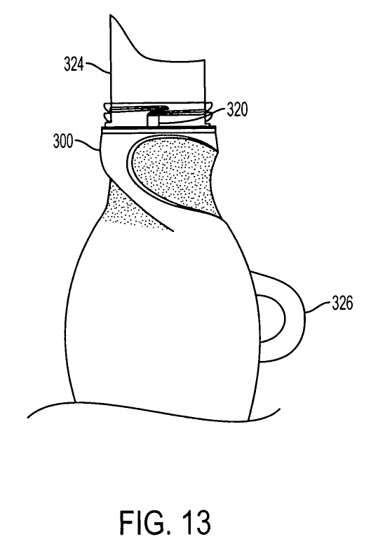

As illustrated in FIGS. 11 and 12 the orientation components can be threads 322, containing a stop 320 that ensures alignment of an attachment such as a dispensing spout 324 (See FIG. 13), in a particular position relative to the container 300. The presence of the stop 320 ensures that the attachment is in a specific alignment relative to the container. An additional attachment, such as a closure, can then be placed and secured over the dispensing feature, for example, by threads on either the dispensing feature or the container.

As illustrated in FIG. 13, the attachment can be a dispensing feature 324, such as a spout. Due to the presence of the stop 320 (see FIGS. 11 and 12) along the orientation component/threads 322, the dispensing spout 324 is aligned with the side of the container 300 opposite to the handle 326.

The present invention is advantageous in that it allows for a particular feature on the attachment to have a specific orientation relative to the cross section of the container. This allows a user to unscrew and rescrew an attachment while maintaining this specific orientation. For instance, some containers come with a seal over the neck that must be removed in order to utilize the dispensing feature of the attachment. Thus, having a removable feature such as a spout aligned with a certain face of the container is desired. For example, it is far preferable to have the dispensing feature of a shampoo bottle line up with the front face of the container, or the dispensing feature of a large liquid detergent bottle line up with the side face of container that is opposite to the side having a handle.

The presence of a stop on the orientation component of the container allows for easy, secure placement of the attachment. Thus, the risk of the attachment separating from the container post-manufacture (i.e. during transport or during consumer use) is greatly reduced. This quality makes the product far more desirable to consumers. Also, the existence of the stop eliminates the need for using heat to secure the dispensing attachment to the container, which saves time and money during the manufacture process.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1) A method of making a PET container, the method comprising:
stretch blow molding the container from a preform, the container having an outside feature and a finish with an orientation component, the orientation component having a predetermined orientation relative to the outside feature of the container;
molding an attachment having an orientation component, the orientation component having a predetermined orientation relative to an outside feature of the attachment; and
assembling the orientation component of the attachment and the orientation component of the container, such that the outside feature of the attachment has a specified orientation relative to the outside feature of the container.

2) The method of claim 1 wherein the outside feature of the attachment is a geometric shape.

3) The method of claim 1 wherein the outside feature of the container is embossed on the closure.

4) The method of claim 1 wherein the outside feature of the attachment is a label-receiving surface.

5) The method of claim 1 wherein the outside feature of the attachment is a dispensing feature.

6) The method of claim 1 wherein the orientation component of the finish of the container comprises a stop.

7) The method of claim 1 wherein the outside feature of the container is a polygonal cross section.

8) The method of claim 1 further comprising the creation of a moil on the container during the blow-molding process and removal of the moil.

9) A container and attachment manufactured by the method of claim 1.

10) The method of claim 1 further comprising injection molding the preform.

11) The method of claim 1 further comprising heating the preform prior to stretch blow molding the container.

12) The method of claim 1 wherein the attachment is injection blow molded.

13) The method of claim 1 wherein the orientation components form a bayonet-type connection.

14) The method of claim 1 wherein the orientation components are threads.

15) A method of making a PET plastic container having a face and an attachment in a desired orientation, comprising:
blow molding the container from a preform, the container having a finish with an orientation component such that the orientation component has a predetermined orientation relative to the face of the container;
molding the attachment with an orientation component, the orientation component having a predetermined orientation relative to an outside feature of the attachment; and
connecting the attachment to the container via the orientation components, such that the outside feature of the attachment has a specified orientation relative to the face of the container.

16) The method of claim 15 wherein the outside feature is a geometric shape.

17) The method of claim 15 wherein the outside feature is embossed on the attachment.

18) The method of claim 15 wherein the face of the container includes a label-receiving surface.

19) The method of claim 15 wherein the outside feature is a dispensing feature.

20) The method of claim 15 wherein the orientation component of the container comprises a stop.
